(19) United States
(12) Patent Application Publication
(10) Pub. No.: US 2007/0085842 A1
(43) Pub. Date: Apr. 19, 2007

(54) Detector for use with data encoding pattern

(76) Inventor: Maurizio Pilu, Stoke Gifford (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/491,174

(22) Filed: Jul. 24, 2006

(30) Foreign Application Priority Data
Oct. 13, 2005 (GB) 0520773.3

(51) Int. Cl. G09G 5/00

(52) U.S. Cl. 345/179

(57) ABSTRACT

A detector for use with a data encoding pattern, the pattern comprising a plurality of markings, wherein the detector is operable to generate pattern data representing a portion of the pattern imaged by an image capture device of the detector, process the pattern data in order to generate a model representing a form of the markings for the pattern, and use at least one of the pattern data and model data representing the generated model to determine a position for the detector, a corresponding method and apparatus.

### CLAIM TO PRIORITY

This application claims priority from co-pending United Kingdom utility application entitled, “Detector for use with Data Encoding Pattern” having serial no. GB 0520773.3, filed Oct. 13, 2005, which is entirely incorporated herein by reference.

### FIELD OF THE INVENTION

The present invention relates generally to a detector, and more specifically, but not exclusively, to a detector for use with a data encoding pattern.

### BACKGROUND

Many digital pen and paper type systems have been proposed. One that is in use is the Anoto system, which can be implemented using a device such as the Logitech IO2 pen, available from Logitech of 6505 Kaiser Drive, Fremont, Calif. 94555, USA. Generally, using such technology, the pen acting as detector senses a position determining pattern that has been printed onto a page and an evaluation of the pen's position, and movements, is made using data collected by the pen.

WO 03/046708 discloses a system of this kind. In the known Anoto type arrangements, the pen is connected by a Universal Serial Bus (USB) cable or wirelessly to a processing device such as a mobile telephone or a personal computer. The processing device receives data from the pen and can identify the document which has been marked by the pen. This can result in the processing device determining information about how the document should be handled. This information may identify an application, perhaps stored on the processing device or held remotely, which enables the information from the pen to be processed.

In general, a data encoding pattern for use with a system as described is printed using specialist equipment and/or inks. This is in part due to the limitations of detectors, such as a digital pen, in imaging the pattern, and in general, such patterns must be accurately printed to within a fine tolerance in order for a detector such as those described above to be able to effectively use the pattern. In the case that such patterns are printed using conventional and/or generic laser or inkjet printers, for example, using arbitrary media, the quality of the pattern can vary dramatically, and current detectors are generally unable to utilise patterns printed in this manner.

### SUMMARY

According to a first aspect of the present invention there is provided a detector for use with a data encoding pattern, the pattern comprising a plurality of markings, wherein the detector is operable to generate pattern data representing a portion of the pattern imaged by an image capture device of the detector, process the pattern data in order to generate a model representing a form of the markings for the pattern, and use at least one of the pattern data and model data representing the generated model to determine a position for the detector.

According to a second aspect of the present invention there is provided a method of using a data encoding pattern comprising a plurality of markings, the method comprising using a detector, generating pattern data representing an imaged portion of the pattern, and processing the pattern data in order to generate model data for the pattern representing a form of the markings.

According to a third aspect of the present invention there is provided image processing apparatus comprising an image capture device operable to generate image data representing a at least a portion of a data encoding pattern composed from a plurality of markings, a processor operable to process the image data, wherein the processor is operable, using the processed image data, to generate model data for the pattern representing a statistical model of a form of markings.

### BRIEF DESCRIPTION OF THE FIGURES

For a better understanding of the present invention, and to further highlight the ways in which it may be brought into effect, embodiments will now be described, by way of example only, with reference to the following drawings in which:

FIG. 1 is a schematic representation of a product comprising a data encoding pattern and content;

FIG. 2 is schematic representation of a portion of an exemplary data encoding pattern;

FIG. 3 is a schematic representation of a detector for use with the product of FIG. 1;

FIG. 4 is a schematic representation of respective portions of data encoding patterns printed using an inkjet and a laserjet printer; and

FIG. 5 is a flowchart representing an exemplary procedure for using the detector of FIG. 3 according to an embodiment.

It should be emphasised that the term “comprises/comprising” when used in this specification specifies the presence of stated features, integers, steps or components but does not preclude the presence or addition of one or more other features, integers, steps, components or groups thereof

### DETAILED DESCRIPTION OF PREFERRED EMBODIMENTS

Referring to FIG. 1, a document 100 for use in a digital pen and paper system comprises a carrier 102 in the form of a single sheet of paper 104 with position identifying markings 106 printed on some parts of it to form areas 107 of a position identifying pattern 108. Also printed on the paper 104 are further markings 109 which are clearly visible to a human user of the form, and which make up the content of the document 100. The content 109 will obviously depend entirely on the intended use of the document. The content, format or use of the document described with reference to FIG. 1 is not intended to be limiting.

In this case an example of a very simple questionnaire document is shown. The content comprises a number of boxes 110, 112 which can be pre-printed with user specific information such as the user's name 114 and a document identification number 116. The content further comprises a number of check boxes 118 any one of which can be marked by a user, and two larger boxes 120, 121 in which the user can write comments, as well as some printed text and images. The form content also comprises a send box 122 which can be checked by the user when they have completed the questionnaire. When ticked or marked, this can initiate a document completion process by which pen stroke data and typographical information on the form such as the headings or labels 124 for the various boxes 110, 112, 118, 120 is forwarded for processing for example.

A position identifying pattern 108 can be printed onto the parts of the form which the user is expected to write on or mark, within the check boxes 118, the comments boxes 120, 121 and the send box 122 for example, or over the entire page.

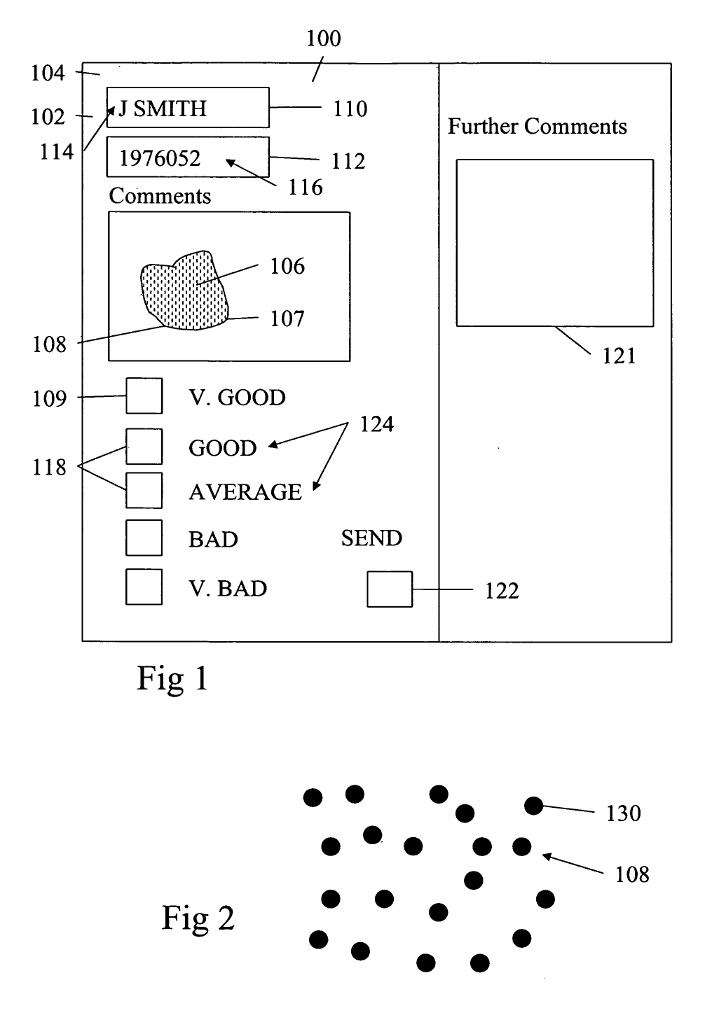

Referring to FIG. 2, an exemplary position identifying pattern 108 is made up of a number of markings 130. The arrangement of the markings defines an imaginary pattern space, and only a small part of the pattern space need be taken up by the pattern on the document 100. By allocating a known area of the pattern space to the document 100, for example by means of a co-ordinate reference, the document and any position on the patterned parts of it can be identified from the pattern printed on it. It will be appreciated that many position identifying patterns can be used. Some examples of suitable patterns are described in WO 00/73983, WO 01/26033 and WO 01/71643 for example.

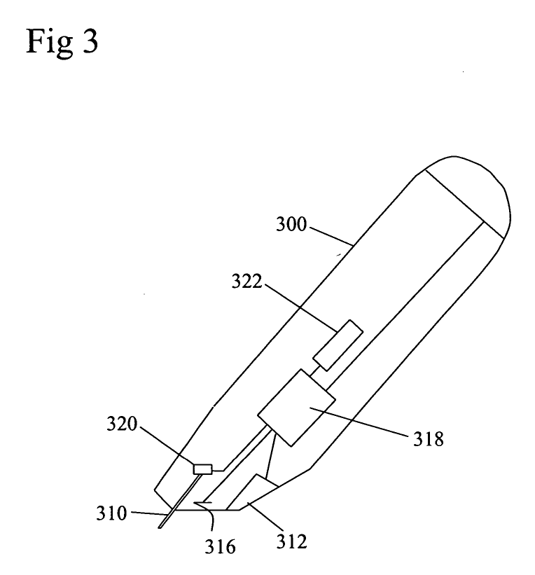

Referring to FIG. 3, a digital pen 300 comprises a writing stylus 310, and a camera 312. The camera 312 is arranged to image an area adjacent to the tip 311 of the pen stylus 310. A processor 318 processes images from the camera 312. A pressure sensor 320 detects when the stylus 310 is in contact with the document 100 and triggers operation of the camera 312. Whenever the pen is being used on a patterned area of the document 100, the processor 318 can therefore determine from the pattern 108 the position of the stylus of the pen whenever it is in contact with the document 100. From this it can determine the position and shape of any marks made on the patterned areas of the document 100. This information is stored in a memory 322 in the pen as it is being used.

The pen can be provided with an output port which can comprise at least one electrical contact that connects to corresponding contacts on a base station (not shown). Alternatively, the pen and base station can communicate wirelessly using an infra-red or radio frequency communications link such as Wi-Fi or Bluetooth for example. Other alternatives are possible.

Although reference is made herein to a digital pen (and paper system) comprising a camera this is not intended to be limiting, as it will be appreciated that all which is required in order to effectively image a pattern is an image capturing device. Such a device can be incorporated into a number of products, not just a pen. For example, an image capture device can be incorporated into a mobile station such as a mobile telephone or pager, or in a personal digital assistant.

According to an embodiment, the pattern 108 and content can be printed to the carrier 102 using a conventional inkjet or laserjet printer. The printer need not be modified, or comprise specialist inks for printing a pattern such as 108 (e.g. IR inks).

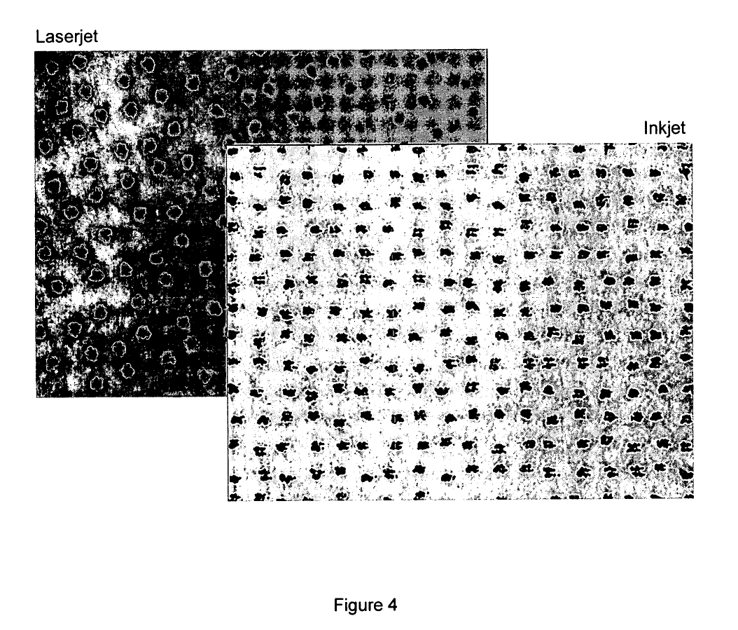

FIG. 4 is a schematic representation of respective portions of data encoding patterns printed using an inkjet and a laserjet printer. The figure illustrates, broadly, the difference in markings for a pattern when printed using different printing devices, and the variability in marking size, position and quality which exists.

According to an embodiment, a detector, such as pen 300 for example, which is operable to sense its position relative to a surface comprising a pattern such as 108 is further operable, using processor 318 to generate a model, such as a statistical model for example, of the markings 106 used to encode data in the pattern 108. More specifically, variability in the form and relative disposition of markings on a product (such as carrier 102) printed using various types of printers and/or media can be determined using the detector 300 as it is being used with the product in question. Pen 300 can therefore generate a model of pattern markers as it is being used with the product upon which the pattern is printed. As the model is generated, it can be reinforced with more precise information using the marker locations from subsequently imaged portions of the pattern. Other alternatives are possible. For example, a model of the type of markers present for a pattern can be generated using data representing a collection of predetermined marking types, with a best match associated with a particular marker based on data collected by the detector when used with the pattern in question. A statistical model can be a hidden Markov model, for example.

As the detector, such as the pen 300 for example, is moved across the surface of a product which has a pattern printed on it, the pen generates pattern data representing an imaged portion of the pattern. The pattern data is processed by processor 318. The processed data can be used to generate a model representing the markings for the pattern. More specifically, the processed data is used to progressively determine a most likely printer/medium combination which has resulted in the pattern being used by the detector. The generated model can be used to improve the accuracy of the detector in determining its position using the pattern. For example, as the model is progressively improved by continued use of the detector with the pattern, the pen can adapt its behaviour, and more specifically can adapt a pattern imaging algorithm used to determine position. A particular model can be stored in a memory of the pen for future use, which is especially advantageous in the case that a user only has a single printer, in which case it is likely that the same pattern will result from subsequent print operations by the user. Instead of a progressive improvement in model accuracy (by imaging pattern potions continuously, or at a predetermined sample rate for example), the model can be generated from a single image portion of the pattern obtained as the detector is used with the product comprising the pattern.

The detector can comprise data stored in a memory thereof representing certain information about markings for a pattern, such as statistical information. For example, the detector can store information relating to a typical marking density and/or colour etc. When imaging a portion of a pattern, the data can be matched against that collected by the detector in order to help determine a marking type, e.g. whether the marking was printed using an inkjet or laserjet printer, and what media has been used for example.

Further, the generated model can comprise data relating to a writing style of a user, which can be generated before or during use of the detector, in order to optimise the position determining capabilities of the detector.

Hence, the detector is operable to generate a model representing markings for a data encoding pattern which has been printed on the surface of a product such as a carrier, for example. The pattern can be printed using a conventional laser or inkjet printer, on conventional paper, and the detector can adapt the algorithm it uses to determine its position with respect to the product surface by generating a model of the markings from which the pattern is composed. The model can be refined as the detector is used with the product, for example by using images of the pattern captured at successive different times corresponding to different position of the detector.

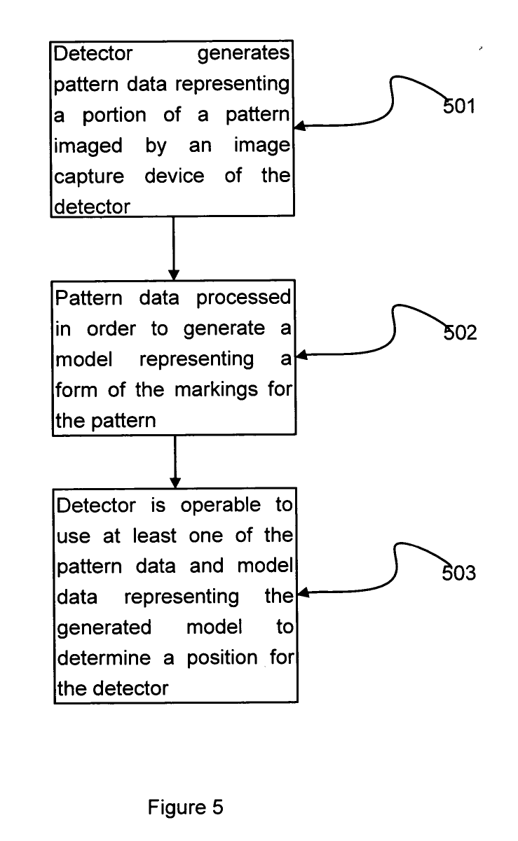

Accordingly, and with reference to FIG. 5, a detector for use with a data encoding pattern composed from a plurality of markings, is operable, at step 501, to generate pattern data representing a portion of the pattern imaged by an image capture device of the detector. The image capture device can be in the form of a conventional CCD or CMOS device, and can be adapted to detect visible information, or information which is not visible (e.g. IR). The pattern data comprises information relating to at least one of a colour, density, size, shape and disposition of markings.

At step 502 the pattern data processed in order to generate a model representing a form of the markings for the pattern. The processing can be performed using a processor of the detector. More specifically, model data is generated representing the model. The model data comprises data which represents at least one of a type of device which was used to print the markings, and the type of surface upon which the markings have been printed. The model data can be a statistical model which can be refined as more pattern data is generated by the detector.

At step 503, the detector is operable to use at least one of the pattern data and model data representing the generated model to determine a position for the detector. The determined position is a position of the detector with respect to the pattern, or with respect to some other suitable frame of reference, such as a point on the surface of a product upon which the pattern is printed for example.

1. A detector for use with a data encoding pattern, the pattern comprising a plurality of markings, wherein the detector is operable to:
generate pattern data representing a portion of the pattern imaged by an image capture device of the detector;
process the pattern data in order to generate a model representing a form of the markings for the pattern; and
use at least one of the pattern data and model data representing the generated model to determine a position for the detector.

2. A detector as claimed in claim 1 in the form of a digital pen.

3. A detector as claimed in claim 1, wherein the detector is operable to use the model data to determine a position for the detector by adapting a position determining algorithm of the detector on the basis of the model data.

4. A detector as claimed in claim 1, wherein the generated model is continuously refined using pattern data from pattern image portions imaged by the detector as it is used.

5. A method of using a data encoding pattern comprising a plurality of markings, the method comprising:
using a detector, generating pattern data representing an imaged portion of the pattern; and
processing the pattern data in order to generate model data for the pattern representing a form of the markings.

6. A method as claimed in claim 5, further comprising:
using at least one of the model data and the pattern data to determine a position for the detector.

7. A method as claimed in claim 5, wherein the model data comprises information relating to a type of marking for the pattern.

8. A method as claimed in claim 5, wherein the model data is continuously generated and/or refined as the detector is used with the pattern.

9. A method as claimed in claim 5, wherein the form of the markings is dependent on at least one of the device used to print the pattern and the medium upon which the pattern is printed.

10. A method as claimed in claim 5, wherein the model is a statistical model.

11. A method as claimed in claim 5, further comprising storing the model data in a detector memory.

12. A method as claimed in claim 5, wherein the model data comprises information relating to a typical marking density for a marking printed using a printing device.

13. A method as claimed in claim 5, further comprising:
using data relating to the density of markings for the pattern to generate the model data.

14. A method as claimed in claim 5, wherein the model data is generated from data representing a plurality of exemplary marking types stored in a look-up table of the detector.

15. A method as claimed in claim 5, further comprising using the model data to determine a position for the detector by adapting a position determining algorithm of the detector on the basis of the model data.

16. Image processing apparatus comprising:
an image capture device operable to generate image data representing a at least a portion of a data encoding pattern composed from a plurality of markings;
a processor operable to process the image data, wherein the processor is operable, using the processed image data, to generate model data for the pattern representing a statistical model of a form of markings.

17. Image capture apparatus as claimed in claim 16, wherein processing the image data comprises:
determining, using the image data, the type of markings from which the pattern is composed.

18. Image capture apparatus as claimed in claim 16, wherein the processor is operable to use the image data in order to determine a position of the apparatus with respect to the pattern.

19. Image capture apparatus as claimed in claim 16, wherein the processor is adapted to determine a position using a position determining algorithm stored in a memory of the apparatus.

20. Image capture apparatus as claimed in claim 16, wherein the model data is continuously updated and/or refined using the processor as image data is generated from the data encoding pattern.
